(19) United States
(12) Patent Application Publication
(10) Pub. No.: US 2026/0280134 A1
(43) Pub. Date: Sep. 17, 2026

(54) RADIO TRANSMISSION SYSTEM

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/676,347

(22) Filed: May 13, 2026

Related U.S. Application Data
(63) Continuation of application No. PCT/JP2024/038473, filed on Oct. 29, 2024.

(30) Foreign Application Priority Data
Nov. 15, 2023 (JP) 2023-194312

(51) Int. Cl. H01Q 13/20; H01Q 19/18

(52) U.S. Cl. CPC H01Q 13/203; H01Q 19/18

(57) ABSTRACT

A radio transmission system which achieves both the improvement of a radio-wave propagation environment and the reduction of the occurrence of leakage of radio waves to the outside of a required space is provided. The radio transmission system comprises: a plurality of electromagnetic-wave reflecting apparatuses provided on respective sides of a passage along a traveling direction of the passage, each of the electromagnetic-wave reflecting apparatuses being configured to reflect a radio wave in a predetermined band selected from 1 MHz or higher and 300 GHz or lower; and a leaky coaxial cable disposed in an area surrounded by the plurality of the electromagnetic-wave reflecting apparatuses provided on the respective sides of the passage and a floor surface of the passage, the leaky coaxial cable being connected to a base station.

### INCORPORATION BY REFERENCE

This application is based upon and claims the benefit of priority from Japanese patent application No. 2023-194312, filed on Nov. 15, 2023, and PCT application No. PCT/JP2024/038473 filed on Oct. 29, 2024, the disclosure of which is incorporated herein in its entirety by reference.

### BACKGROUND

The present disclosure relates to a radio transmission system.

Conventionally, a radio transmission system including: a base station that transmits and receives a radio wave in a desired frequency band selected from a range of 1 GHz to 300 GHz; and an electromagnetic-wave reflecting apparatus having a reflection surface that reflects the radio wave and provided along at least a part of a production line in which production equipment that transmits and receives the radio wave is provided has been used (see, for example, International Patent Publication No. WO 2021/199504).

### SUMMARY

It should be noted that, in some cases, depending on the environment in which a radio transmission system is provided, a place where a base station is disposed is limited, and hence a good positional relationship between the base station and an electromagnetic-wave reflecting apparatus cannot be secured. In such a case, there is a possibility that blind zones cannot be reduced, and hence a radio-wave propagation state cannot be sufficiently improved. Further, in order to avoid interference with other commercial radio waves, there has been a demand to reduce the occurrence of leakage of radio waves to the outside of a desired area.

Therefore, an object of the present disclosure is to provide a radio transmission system which achieves both the improvement of a radio-wave propagation environment and the reduction of the occurrence of leakage of radio waves to the outside of a required space.

A radio transmission system according to an embodiment of the present disclosure comprises: a plurality of electromagnetic-wave reflecting apparatuses provided on respective sides of a passage along a traveling direction of the passage, each of the electromagnetic-wave reflecting apparatuses being configured to reflect a radio wave in a predetermined band selected from 1 MHz or higher and 300 GHz or lower; and a leaky coaxial cable disposed in an area surrounded by the plurality of the electromagnetic-wave reflecting apparatuses provided on the respective sides of the passage and a floor surface of the passage, the leaky coaxial cable being connected to a base station.

It is possible to provide a radio transmission system which achieves both the improvement of a radio-wave propagation environment and the reduction of the occurrence of leakage of radio waves to the outside of a required space.

The above and other objects, features and advantages of the present disclosure will become more fully understood from the detailed description given hereinbelow and the accompanying drawings.

### BRIEF DESCRIPTION OF DRAWINGS

FIG. 1A is a diagram showing an example of a road 32 in which a radio transmission system 1 according to an embodiment is disposed;

FIG. 1B is a diagram showing an example of a configuration of a leaky coaxial cable 80;

FIG. 2A is a diagram showing an example of a configuration of an electromagnetic-wave reflecting fence 100A;

FIG. 2B is a diagram showing an example of a production line 35 of a factory in which the radio transmission system 1 according to the embodiment is disposed;

FIG. 3 is a diagram showing an example of a layer structure of a reflection panel 10; and

FIG. 4 is a diagram showing an example of a configuration of a unit cell 20 of a conductive pattern 15 composed of hollow patterns 151.

### DESCRIPTION OF EMBODIMENTS

Embodiments to which a radio transmission system according to the present disclosure is applied will be described hereinafter. In the following description, the same elements are denoted by the same reference symbols, and redundant descriptions thereof may be omitted.

In the description given below, an XYZ coordinate system is defined. A direction parallel to an X-axis (an X-direction), a direction parallel to a Y-axis (a Y-direction), and a direction parallel to a Z-axis (a Z-direction) are orthogonal to each other. Further, for convenience of explanation, a −Z direction side may be referred to as a lower side or bottom, and a +Z direction side may be referred to as an upper side or top. Further, a plan view refers to an XY plan view. Further, in the following description, the length, the thickness, and the like of each component may be exaggerated so as to make the structure easier to understand. Further, regarding the words such as parallel, a right angle, orthogonal, horizontal, vertical, up/down, and the like, deviations that do not impair the effects of the embodiments are allowed.

In the embodiments, in a radio transmission system used indoors and outdoors, blind zones are reduced by using an electromagnetic-wave reflecting apparatus and a leaky coaxial cable. The term “blind zone” used in this specification refers to a zone in which the received power is lowered by 10 dB or more due to the presence of a shielding object compared with the surrounding receiving environment in which there is no shielding object. In general, electromagnetic waves of 3 THz or lower are referred to as radio waves. In this specification, communication waves transmitted from a base station are referred to as “radio waves”, and electromagnetic waves in general are referred to as “electromagnetic waves”.

The blind zone includes not only a two-dimensional area but also a three-dimensional space. If production equipment, a sensor, a mobile communication terminal, or the like equipped with a radio communication function is positioned in the blind zone, it becomes difficult to transmit/receive signals to/from the base station. Therefore, an electromagnetic-wave reflecting apparatus and a leaky coaxial cable are introduced to reduce the blind zones and improve the radio wave environment.

### EMBODIMENTS

### Radio Transmission System 1 Disposed Outdoors

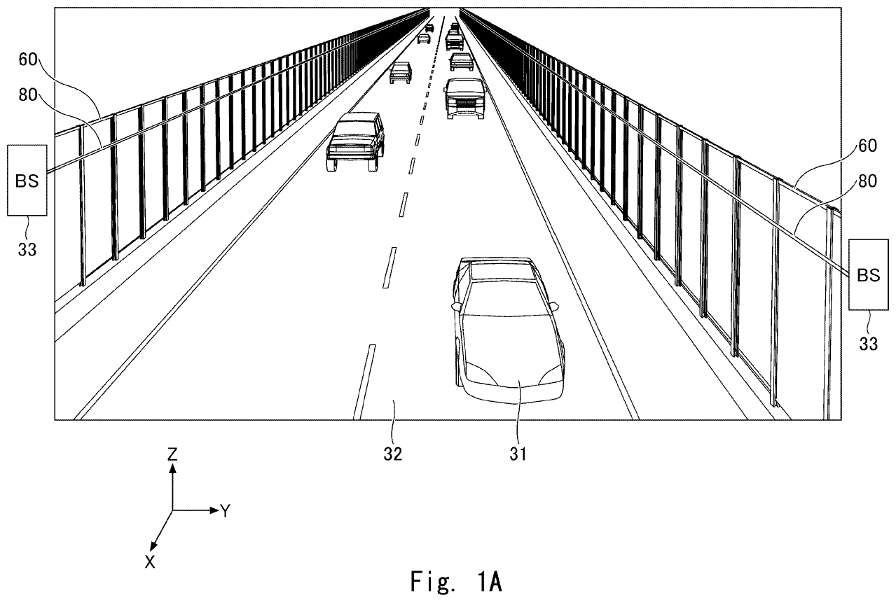

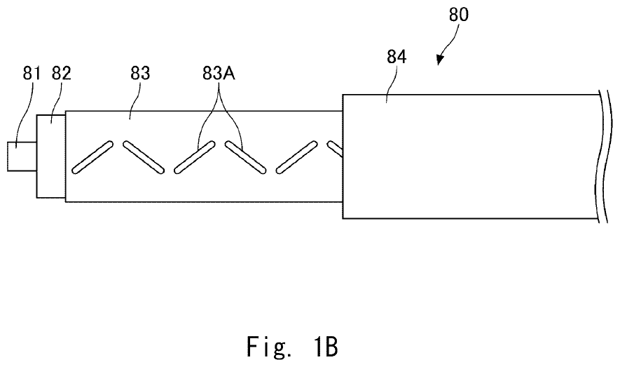

FIG. 1A is a diagram showing an example of a road 32 in which a radio transmission system 1 according to an embodiment is disposed. FIG. 1A shows the radio transmission system 1 disposed outdoors as an example. The road 32 is an example of a passage, which is an example of a highway. A configuration in which the radio transmission system 1 is disposed in the road 32 will be described below as an example.

However, the radio transmission system 1 can also be disposed in an outdoor facility such as a medical site, an event hall, a railway line, or an indoor facility such as a factory, a plant, an office, or a commercial facility other than the road 32.

The radio transmission system 1 includes base stations 33, electromagnetic-wave reflecting apparatuses 60, and leaky coaxial cables 80. As an example, the base station 33 performs radio communication at a frequency included in a frequency band of 1 MHz or higher and 300 GHz or lower. The electromagnetic-wave reflecting apparatus 60 includes, for example, a reflection panel which reflects a radio wave of the frequency of the base station 33. As an example, the leaky coaxial cable 80 is connected to an antenna terminal of the base station 33, is provided along the road 32, and performs radio communication at a frequency included in a frequency band of 1 MHz or higher and 300 GHz or lower.

FIG. 1A shows, as an example of an outdoor environment, a radio environment in which the road 32 is defined as a communication area. In the coordinate system of FIG. 1A, a length direction of the road 32 is defined as the X direction, a width direction of the road 32 is defined as the Y direction, and a direction perpendicular to the road surface is defined as the Z direction. A large number of vehicles 31 travel on the road 32. Each of the vehicles 31 may be a vehicle equipped with an automated driving function or a semi-automated driving function, or a vehicle that is not equipped with an automated driving function. In either case, not only the mobile terminal possessed by a driver or a passenger but also the vehicle 31 itself has a radio communication function, and a large amount of data is transmitted and received between the vehicle 31 and a control/management system.

In order to achieve radio communication between a movable body such as the vehicle 31 and a network, the base station 33 and the leaky coaxial cable 80 are disposed along the road 32. The leaky coaxial cable 80 is connected to the base station 33, and emits a radio wave supplied from the base station 33. Here, a configuration in which the base station 33 emits a radio wave directly from an antenna and supplies a radio wave to the leaky coaxial cable 80, and the leaky coaxial cable 80, also, emits a radio wave will be described. However, the base station 33 may be configured so that it only outputs a radio wave to the leaky coaxial cable 80 and does not emit a radio wave.

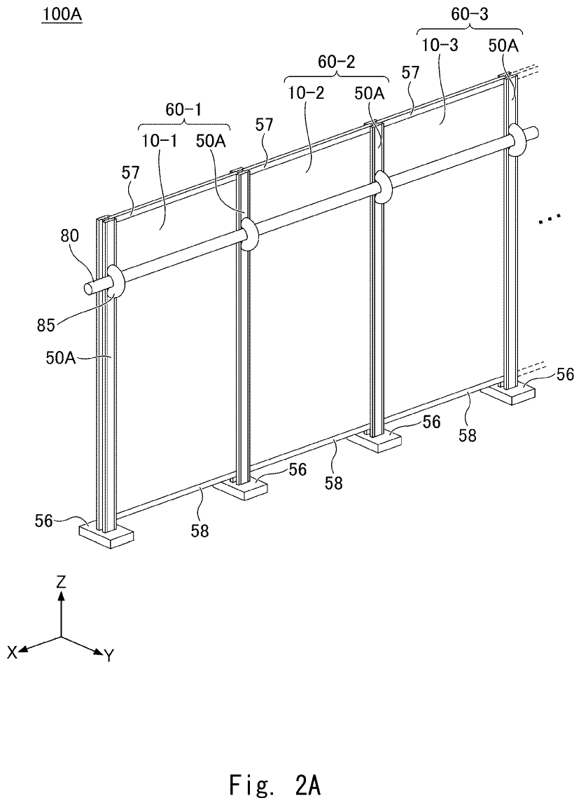

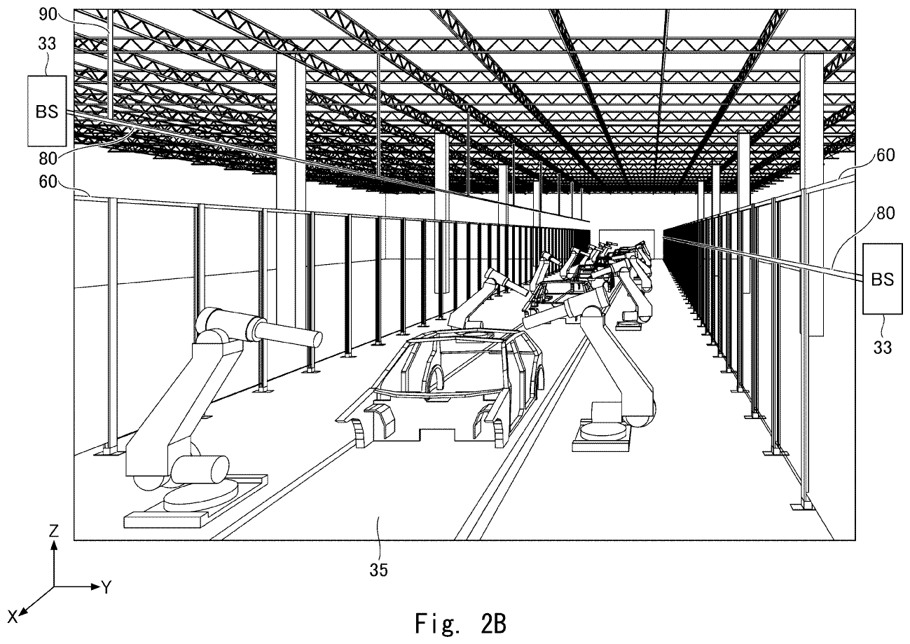

As an example, the base station 33 and the leaky coaxial cable 80 transmit and receive signals or data between them and the vehicle 31 at a predetermined frequency in a frequency band of 1 MHz or higher and 300 GHz or lower. Further, in consideration of the topography and the surrounding environment of the road 32 and the presence of a large number of the vehicles 31, a plurality of the electromagnetic-wave reflecting apparatuses 60 are disposed on both sides of the road 32 (on respective sides of the road 32 in the width direction) along the direction in which the vehicle 31 travels on the road 32 so that a radio wave of a high frequency with a poor straight-traveling property can more reliably reach each of the vehicles 31 from the base station 33 and the leaky coaxial cable 80. The plurality of the electromagnetic-wave reflecting apparatuses 60 may be connected to each other and installed on the shoulder of the road 32 as an electromagnetic-wave reflecting fence. The electromagnetic-wave reflecting fence will be described later with reference to FIG. 2A.

As an example, radio waves transmitted and received by the base station 33 and the leaky coaxial cable 80 are preferably radio waves in the frequency band of 1 GHz to 300 GHz including the frequency band of Sub-6 such as the 5th generation mobile communication system (5G) and the millimeter wave band. At present, the frequency band of Sub-6 and the 28 GHz band included in the millimeter wave band are used, and in the next-generation 6G mobile communication standards, it is expected that the frequency band used will be extended to the sub-terahertz band. By using such a high frequency band, the communication bandwidth is greatly extended, and a large amount of data communication can be performed with a low delay.

Further, radio waves transmitted and received by the base station 33 and the leaky coaxial cable 80 may be in Long Term Evolution (LTE), LTE-Advanced (LTE-A), Ultra Mobile Broadband (UMB), or Citizens Broadband Radio Service (CBRS). Further, radio waves transmitted and received by the base station 33 and the leaky coaxial cable 80 may be in IEEE802.11 (Wi-Fi (registered trademark), IEEE802.16 (WiMAX (registered trademark)), IEEE802.20, Ultra-Wideband (UWB), Bluetooth (registered trademark), Low Power Wide Area (LPWA), or the like.

As an example, each of the uppermost parts (the upper ends) of the electromagnetic-wave reflecting apparatuses 60 is installed at a position higher than that of the base station 33. The base station 33 preferably includes a directional antenna in which a beam is formed toward the road 32 at a position between the electromagnetic-wave reflecting apparatuses 60 disposed on the respective sides of the road 32. Further, the leaky coaxial cables 80 are disposed on both sides of the road 32 along the direction in which the vehicle 31 travels on the road 32 together with the electromagnetic-wave reflecting apparatuses 60.

In each of the leaky coaxial cables 80, a degree of flexibility in bending and winding is lower than that in an ordinary coaxial cable. Therefore, for example, it is not practical to route the leaky coaxial cable while bending it along the floor surface or under the floor. For this reason, in terms of routing, it is advantageous to arrange the leaky coaxial cable 80 along the electromagnetic-wave reflecting apparatuses 60 disposed linearly. Further, if the leaky coaxial cable 80 is disposed at an excessively high position, it is difficult to obtain a sufficient intensity of a radio wave emitted downward. Therefore, in terms of constructing a radio communication area, it is advantageous to attach the leaky coaxial cable 80 to the electromagnetic-wave reflecting apparatus 60 having a height of 2 m to 3 m or less.

The leaky coaxial cables 80 are disposed closer to the center side of the width of the road 32 than the electromagnetic-wave reflecting apparatuses 60 on both sides of the road 32. That is, the leaky coaxial cable 80 is disposed in an area surrounded by the plurality of the electromagnetic-wave reflecting apparatuses 60 provided on the respective sides of the road 32 and the road surface (the floor surface) of the road 32, and is connected to an antenna terminal of the base station 33. Further, as an example, the leaky coaxial cable 80 is provided at a position lower than that of the uppermost part (the upper end) of each of the electromagnetic-wave reflecting apparatuses 60 in this area.

The area surrounded by the plurality of the electromagnetic-wave reflecting apparatuses 60 provided on the respective sides of the road 32 and the road surface (the floor surface) of the road 32 includes positions higher than those of the uppermost parts (the upper ends) of the electromagnetic-wave reflecting apparatuses 60 in the height direction. Since the leaky coaxial cable 80 only needs to be disposed in this area, it may be provided at a position higher than that of the uppermost part (the upper end) of each of the electromagnetic-wave reflecting apparatuses 60.

Further, the area surrounded by the plurality of the electromagnetic-wave reflecting apparatuses 60 provided on the respective sides of the road 32 and the road surface (the floor surface) of the road 32 also includes an area directly above the electromagnetic-wave reflecting apparatuses 60. That is, the leaky coaxial cable 80 may be located directly above the electromagnetic-wave reflecting apparatuses 60. For example, the leaky coaxial cable 80 may be provided along the uppermost part (the upper end) of each of the electromagnetic-wave reflecting apparatuses 60, or may be provided directly above the electromagnetic-wave reflecting apparatuses 60 through a fixing member or the like attached to the uppermost parts (the upper ends) of the electromagnetic-wave reflecting apparatuses 60. The fact that the leaky coaxial cable 80 is positioned directly above the electromagnetic-wave reflecting apparatuses 60 means that, when viewed from directly above, the leaky coaxial cable 80 and the electromagnetic-wave reflecting apparatuses 60 overlap each other in the width direction of the road 32. Further, when the leaky coaxial cable 80 is positioned directly above the electromagnetic-wave reflecting apparatuses 60, slots 83A are preferably directed to the center side of the road 32 in the width direction. This is because radio waves emitted from the slots 83A can be emitted toward the road 32.

The electromagnetic-wave reflecting apparatuses 60 and the leaky coaxial cable 80 are disposed on both sides of the road 32 in addition to the directional antenna of the base station 33, whereby radio waves emitted from the base station 33 and the leaky coaxial cable 80 are efficiently concentrated on the road 32, and the occurrence of leakage of radio waves to the outside of the road 32 is reduced. Thus, the received power outside the electromagnetic-wave reflecting apparatuses 60 on the respective sides of the road 32 becomes lower than an average value or a median value of the received power on the road 32 in which the both sides thereof are located between the electromagnetic-wave reflecting apparatuses 60.

Even if the beam shape is controlled by the base station 33, another vehicle 31 may interfere with Line of Sight (LOS). In such a case, since a radio wave is emitted from the leaky coaxial cable 80 provided along each of both sides of the road 32, it can be delivered to the vehicle 31. Further, radio waves emitted from the base station 33 and the leaky coaxial cable 80 can be reflected by the electromagnetic-wave reflecting apparatuses 60 and delivered to the vehicle 31.

The size of the reflection surface of the electromagnetic-wave reflecting apparatus 60 may be any size which can cover at least an area determined by a radius R of the first Fresnel zone. The radius R of the first Fresnel zone when a radio wave emitted from the antenna of the base station 33 and reflected by the electromagnetic-wave reflecting apparatus 60 reaches the vehicle 31 in phase is defined by the following equation.

$$R = {[ λ d 1 d 2 / ( d 1 + d 2 ) ]}^{1 / 2}$$

where λ is a used wavelength, d1 is a distance from the antenna of the base station 33 to the electromagnetic-wave reflecting apparatus 60, and d2 is a distance from the electromagnetic-wave reflecting apparatus 60 to the antenna of the vehicle 31.

When it is assumed that a distance d1 from the antenna of the base station 33 to the electromagnetic-wave reflecting apparatus 60 is 20.0 mm and a distance d2 from the electromagnetic-wave reflecting apparatus 60 to the vehicle 31 is 10.0 m in the 28 GHz band (a wavelength of about 10.7 mm), it is sufficient that, regarding the size of the reflection surface of the electromagnetic-wave reflecting apparatus 60, one side of the reflection surface is several tens of centimeters. Meanwhile, in order to form an electromagnetic-wave reflecting fence which covers a wide reflection area with a small number of the electromagnetic-wave reflecting apparatuses 60, the width >the length of the reflection surface of the electromagnetic-wave reflecting apparatus 60 may be about 2.0 m×4.0 m. In the embodiment, the electromagnetic-wave reflecting apparatuses 60 are disposed along the road 32 so that the received power on the back side of the reflection surface of each of the electromagnetic-wave reflecting apparatuses 60, that is, in an area outside the road 32 becomes lower than an average value or a median value of the received power on the road 32.

### Configuration of the Leaky Coaxial Cable 80

FIG. 1B is a diagram showing an example of a configuration of the leaky coaxial cable 80. The leaky coaxial cable 80 includes an inner conductor 81, an insulation layer 82, an outer conductor 83, and an insulation film 84. The inner conductor 81 is a core wire, and as an example, it is made of a metal such as copper or aluminum. As an example, the insulation layer 82 is made of an insulator such as foamed polyethylene, and it covers the inner conductor 81 and insulates the inner conductor 81 and the outer conductor 83.

The outer conductor 83 is a cylindrical conductor provided along the outer surface of the insulation layer 82, and as an example, it is made by winding a tape made of a metal such as copper or aluminum around the outer surface of the insulation layer 82. The outer conductor 83 includes a plurality of the slots 83A provided along the direction in which the leaky coaxial cable 80 is extended (the X direction). Although FIG. 1B shows a configuration in which the linear slots 83A are disposed in a wavy manner along the direction in which the leaky coaxial cable 80 is extended, the slots 83A are not limited to having linear shapes and may have various shapes. Further, the plurality of slots are not limited to being arranged in a wavy manner. The insulation film 84 covers the outer surface of the outer conductor 83, and as an example, it is made of a heat-resistant and flame-retardant resin such as polyethylene.

In a state in which one end of the inner conductor 81 of the leaky coaxial cable 80 described above is connected to a signal terminal (a power supply terminal) of the antenna terminals of the base station 33, and one end of the outer conductor 83 is connected to a ground terminal of the antenna terminals of the base station 33, when the base station 33 transmits radio waves, a signal is supplied from the antenna terminal of the base station 33 to the leaky coaxial cable 80, and radio waves are transmitted from the slots 83A to the periphery of the leaky coaxial cable 80. Further, when the base station 33 receives radio waves, radio waves near the leaky coaxial cable 80 are received by the slots 83A, transmitted by the leaky coaxial cable 80, and reach the base station 33.

Therefore, by connecting the leaky coaxial cable 80 to the antenna terminal of the base station 33, a radio communication area can be constructed near the leaky coaxial cable 80 along the road 32. The leaky coaxial cable 80 functions as both a transmission path and an antenna.

### Mounting Structure of the Electromagnetic-Wave Reflecting Apparatus 60, the Electromagnetic-Wave Reflecting Fence 100A, and the Leaky Coaxial Cable 80

FIG. 2A is a diagram showing an example of the configuration of the electromagnetic-wave reflecting fence 100A. The electromagnetic-wave reflecting fence 100A is formed by connecting electromagnetic-wave reflecting apparatuses 60-1, 60-2, and 60-3 (hereinafter may collectively be referred to as “electromagnetic-wave reflecting apparatuses 60” as appropriate) including reflection panels 10-1, 10-2, and 10-3 (hereinafter may collectively be referred to as “reflection panels 10” as appropriate) to each other with frames 50A. That is, the electromagnetic-wave reflecting fence 100A includes a plurality of the electromagnetic-wave reflecting apparatuses 60. The configuration of each of the electromagnetic-wave reflecting apparatuses 60 is the same as the configuration of each of the electromagnetic-wave reflecting apparatuses 60 shown in FIG. 1A.

The coordinate system of FIG. 2A is consistent with the coordinate system of FIG. 1A, and a width or a lateral direction of the reflection panel 10 is defined as the X direction, a thickness direction thereof is defined as the Y direction, and a height direction thereof is defined as the Z direction. Although the electromagnetic-wave reflecting fence 100A is configured by connecting three of the electromagnetic-wave reflecting apparatuses 60 to each other in FIG. 2A, the number of the plurality of the electromagnetic-wave reflecting apparatuses 60 to be connected to each other is determined as appropriate in accordance with the condition of the road 32.

As an example, the electromagnetic-wave reflecting fence 100A shown in FIG. 2A has a reflection surface on the +Y direction side, and is disposed on the right side with respect to a traveling direction (the +X direction) of the road 32. The leaky coaxial cable 80 is disposed on the reflection surface of the electromagnetic-wave reflecting fence 100A. Since the reflection surface of the electromagnetic-wave reflecting fence 100A disposed on the left side with respect to the traveling direction (the +X direction) of the road 32 is located on the −Y direction side, the leaky coaxial cable 80 is disposed on the −Y direction side of the electromagnetic-wave reflecting fence 100A. By providing the leaky coaxial cable 80 on the reflection surface of the electromagnetic-wave reflecting fence 100A on each of the respective sides of the road 32 in this way, a radio communication area can be constructed along the road 32 even at a position away from the base station 33 in the traveling direction of the road 32.

The reflection panel 10 used in the electromagnetic-wave reflecting apparatus 60 reflects electromagnetic waves of 1 MHz or higher and 300 GHz or lower, preferably 1 GHz or higher and 100 GHZ or lower, and more preferably 1 GHz or higher and 80 GHz or lower. The reflection panel 10 has a layer including a conductive film as a reflection film. The conductive film has a predetermined conductive pattern designed in accordance with a desired reflection angle, a desired frequency band, and the like. The conductive pattern includes a periodic pattern, a mesh pattern, a geometric pattern, or the like, and may be formed of a transparent conductive film. The reflection panel 10 has a protective layer having an ultraviolet-light protection function as an outermost layer.

At least a part of the reflection panel 10 may be a non-specular reflection surface on which the incident angle and the reflection angle of an electromagnetic wave are different from each other. The non-specular reflection surface includes a meta-surface, which is an artificial reflection surface designed to reflect a radio wave in a desired direction, in addition to a diffusing surface and a scattering surface. In some cases, it is desirable that the reflection panels 10-1, 10-2, and 10-3 are electrically connected to each other in order to maintain the continuity of the reflection potential. However, in a case where a meta-surface is included in the non-specular reflection surface, the electrical connection between the reflection panels 10 adjacent to each other may not be necessary. By holding the reflection panels 10 adjacent to each other by the frames 50A, the electromagnetic-wave reflecting fence 100A in which the reflection panels 10 are connected to each other in the X direction can be obtained.

The electromagnetic-wave reflecting apparatus 60 may include leg parts 56 which support the frames 50A in addition to the reflection panel 10 and the frames 50A. The electromagnetic-wave reflecting apparatus 60 or the electromagnetic-wave reflecting fence 100A may be made to stand on the road surface by the leg parts 56. The leg parts 56 may be configured to be fixed to the road surface by screws or the like. Conversely, the electromagnetic-wave reflecting apparatus 60 or the electromagnetic-wave reflecting fence 100A may be made to stand on the road surface, and may be movable by including components such as casters. In addition to the frames 50A, a top frame 57 which holds the upper end of the reflection panel 10 and a bottom frame 58 which holds the lower end thereof may be used. In this case, the frames 50A, the top frame 57, and the bottom frame 58 form a frame which holds the entire periphery of the reflection panel 10. The frames 50A may be referred to as “side frames” based on the positional relationship with the top frame 57 and the bottom frame 58. By providing the top frame 57 and the bottom frame 58, the mechanical strength and the safety at the time of conveyance and assembly of the reflection panel 10 are secured. The top frame 57 may be configured so that another reflection panel or another member such as an electromagnetic-wave absorbing panel can be connected to the upper end of the reflection panel 10. Thus, a degree of flexibility in the size and function of the electromagnetic-wave reflecting fence 100A is increased.

Further, as an example, the leaky coaxial cable 80 is fixed to the frames 50A by fixing tools 85. The fixing tools 85 may be any members which can fix the leaky coaxial cable 80 to the electromagnetic-wave reflecting fence 100A. As an example, each of the fixing tools 85 may be a member which forms a mounting hole in the frame 50A, is inserted into the mounting hole while holding the leaky coaxial cable 80, and is fixed with a bolt or the like. The above fixing tool 85 may be made of a metal or a resin.

When the leaky coaxial cable 80 is fixed to the electromagnetic-wave reflecting fence 100A, the following structure may be employed as an example. The height wise position of the leaky coaxial cable 80 from the floor surface may be equal to or lower than the height wise position of the upper end of each of the plurality of the electromagnetic-wave reflecting apparatuses 60 from the floor surface. The height wise position of the leaky coaxial cable 80 from the floor surface is equal to or lower than the height wise position of the upper end of each of the plurality of the electromagnetic-wave reflecting apparatuses 60 from the floor surface, whereby radio waves emitted from the slots 83A can be reflected to the center side of the road 32 in the width direction by the electromagnetic-wave reflecting apparatuses 60, and the occurrence of leakage of radio waves to the outside of the electromagnetic-wave reflecting apparatuses 60 on the respective sides of the road 32 can be reduced. Note that the height wise position of the leaky coaxial cable 80 from the floor surface may be higher than the height wise position of the upper end of each of the plurality of the electromagnetic-wave reflecting apparatuses 60 from the floor surface.

Further, the plurality of the slots 83A of the leaky coaxial cable 80 may be directed to the center side of the road 32 in the width direction. The slots 83A are directed to the center side of the road 32 in the width direction, whereby radio waves emitted from the slots 83A can easily reach the vehicle 31. Note that, although the plurality of the slots 83A of the leaky coaxial cable 80 may be directed in a direction other than to the center side of the road 32 in the width direction, it is not very desirable that the plurality of the slots 83A are directed only in an upward direction in terms of communication efficiency.

Further, a distance D between each of the plurality of the electromagnetic-wave reflecting apparatuses 60 and the leaky coaxial cable 80 in the width direction (the Y direction) of the road 32 may be set to a distance that satisfies D≠(¼+N)×λ, where λ is a wavelength of the radio wave in a free space and N is any natural number. Although not shown in FIG. 2A, the distance D is specifically a distance in the Y direction between the reflection surface of the electromagnetic-wave reflecting apparatus 60 and the slot 83A of the leaky coaxial cable 80 positioned on the center side of the road 32 in the width direction.

The distance D satisfies the above relationship, whereby it is possible to prevent a radio wave emitted from the slot 83A of the leaky coaxial cable 80 to the center side of the road 32 in the width direction and a radio wave reflected by the electromagnetic-wave reflecting apparatus 60 to the center side of the road 32 in the width direction from being in opposite phase, and hence prevent the radio waves from canceling each other out.

Further, the distance D between each of the plurality of the electromagnetic-wave reflecting apparatuses 60 and the leaky coaxial cable 80 may be 0.3 m or shorter. When the distance D is long, the intensity of the reflected wave that is reflected from the leaky coaxial cable 80 by the electromagnetic-wave reflecting apparatus 60 and propagated to the center side of the road 32 in the width direction decreases. Therefore, it is preferable that the leaky coaxial cable 80 is moderately close to the electromagnetic-wave reflecting apparatuses 60.

Further, a width of the road 32 may be 5 m to 20 m. Depending on the intensity of the radio wave, when the maximum intensity is about 10 dBi to 30 dBi as an example, it is a realistic distance as a distance at which the vehicle 31 can receive radio waves emitted from the slots 83A of the leaky coaxial cable 80 disposed on each of both sides of the road 32 and acquire data.

### Radio Transmission System 1 Disposed Indoors

FIG. 2B is a diagram showing an example of a production line 35 of a factory in which the radio transmission system 1 according to the embodiment is disposed. In FIG. 2B, the radio transmission system 1 is disposed indoors. The production line 35 is a belt-shaped production site in which facilities and equipment for assembly and production are disposed as a series of flows. In the Industrial Internet of Things (IoT), industrial apparatuses, equipment, management systems, and the like used in the production line 35 are connected to a network, to thereby improve the production efficiency and ensure the safety at the site.

In order to connect the equipment and the like of the production line 35 to the network, the base stations 33, the electromagnetic-wave reflecting apparatuses 60, and the leaky coaxial cables 80 are disposed similarly to those on the road 32 shown in FIG. 1A. In FIG. 2B, as an example, a plurality of Automatic Guided Vehicles (AGVs) are disposed as equipment used in the production line 35, each of which is connected to the network by communicating with the base stations 33 and the leaky coaxial cables 80. In the production line 35 shown in FIG. 2B, as an example, vehicles are manufactured.

In order to achieve a radio connection between the equipment of the production line 35 and the network, the base stations 33, the electromagnetic-wave reflecting apparatuses 60, and the leaky coaxial cables 80 provide a radio communication area that is long in the horizontal direction. In the technical specification (TS 22.104) of 3rd Generation Partnership Project (3GPP) (registered trademark), which is a standardizing body for mobile communications, a radio communication area in which the aspect ratio of a rectangular area in a horizontal plane is three to five times is indicated as a system requirement. For example, the area size of the use case referred to as “Motion Control” is defined as a length of 50 m×a width of 10 m×a height of 10 m.

In order to cover the production line 35 in a radio communication area provided by the base stations 33, the electromagnetic-wave reflecting apparatuses 60, and the leaky coaxial cables 80 and achieve a network connection of the equipment present in the production line 35, arranging a plurality of the electromagnetic-wave reflecting apparatuses 60 along the traveling direction (the +X direction) of the production line 35 on both sides of the production line 35 and arranging the leaky coaxial cables 80 along the electromagnetic-wave reflecting apparatuses 60 are effective in terms of coverage. This is similar to the case of the road 32 shown in FIG. 1A.

In the coordinate system of FIG. 2B, a length direction (a traveling direction) of the production line 35 is defined as the X direction, a width direction thereof is defined as the Y direction, and a direction perpendicular to the floor surface is defined as the Z direction. A large number of vehicle bodies are conveyed on the production line 35. Although FIG. 2B shows the production line 35 for vehicle bodies as an example, the production line may instead be a production line for products other than vehicles. Equipment such as AGVs disposed near the production line 35 has a radio communication function, and a large amount of data is transmitted and received between the equipment such as AGVs and the control/management system.

In the production line 35 shown in FIG. 2B, the leaky coaxial cable 80 is fixed to the electromagnetic-wave reflecting apparatuses 60 on the +Y direction side. The leaky coaxial cable 80 may be fixed to the electromagnetic-wave reflecting apparatuses 60 by using the fixing tools 85 shown in FIG. 2A as an example. As an example, the height wise position of the leaky coaxial cable 80 on the +Y direction side is lower than the height wise position of the upper end of each of the electromagnetic-wave reflecting apparatuses 60. Further, for example, the height wise position of the base station 33 connected to the leaky coaxial cable 80 on the +Y direction side is lower than the height wise position of the uppermost part (the upper end) of each of the electromagnetic-wave reflecting apparatuses 60 on the +Y direction side.

Further, the leaky coaxial cable 80 on the −Y direction side is suspended from the ceiling by a stay 90. As an example, the height wise position of the leaky coaxial cable 80 on the −Y direction side is higher than the height wise position of the upper end of each of the electromagnetic-wave reflecting apparatuses 60 on the −Y direction side. Further, as an example, the leaky coaxial cable 80 on the −Y direction side is positioned closer to the +Y direction side than each of the electromagnetic-wave reflecting apparatuses 60 on the −Y direction side in the Y direction. This configuration aims to propagate reflected waves to the +Y direction side and reduce the occurrence of leakage of radio waves to the −Y direction side farther than the electromagnetic-wave reflecting apparatuses 60 on the −Y direction side.

Further, as an example, the height wise position of the base station 33 connected to the leaky coaxial cable 80 on the −Y direction side is higher than the height wise position of the uppermost part (the upper end) of each of the electromagnetic-wave reflecting apparatuses 60. However, the height wise position of each of the leaky coaxial cable 80 and the base station 33 on the −Y direction side may be made lower than the height wise position of the uppermost part (the upper end) of each of the electromagnetic-wave reflecting apparatuses 60 by, for example, further increasing the length of the stay 90 which suspends the leaky coaxial cable 80 and lowering the position of a holder (not shown) which holds the base station 33. This configuration is advantageous when a beam is to be emitted from the directional antenna of the base station 33 toward the production line 35.

As shown in FIG. 2B, the radio transmission system 1 can also be disposed indoors, and a radio communication area that is long in the traveling direction of the production line 35 can be realized by using the leaky coaxial cable 80.

### Layer Structure of the Reflection Panel 10

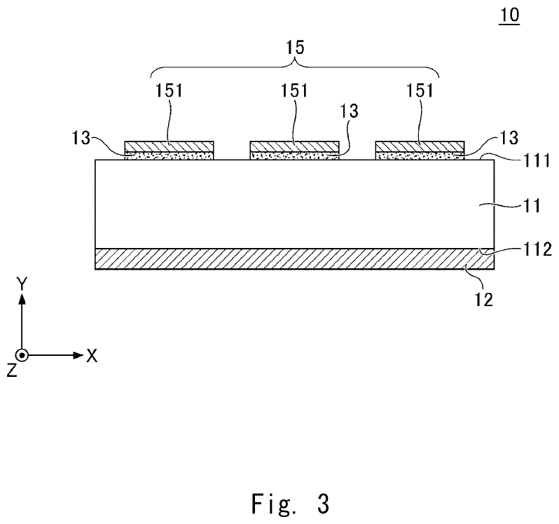

FIG. 3 is a diagram showing an example of a layer structure of the reflection panel 10. The layer structure shown in FIG. 3 is a layer structure in an XY cross section of the reflection panel 10, and a lamination direction is the thickness direction (Y direction) of the reflection panel 10. FIG. 3 shows, as an example, a cross section of the reflection panel 10 of the electromagnetic-wave reflecting apparatus 60 disposed on the −Y direction side of the road 32 or the production line 35 when viewed from the upper side (the +Z direction side).

The reflection panel 10 includes a dielectric layer 11, a periodic conductive pattern 15 provided on one surface 111 of the dielectric layer 11, and a ground layer 12 provided on the other surface 112 of the dielectric layer 11. The conductive pattern 15 forms a reflection surface of the reflection panel 10, and reflects electromagnetic waves of 1 MHz or higher and 300 GHz or lower in a predetermined direction.

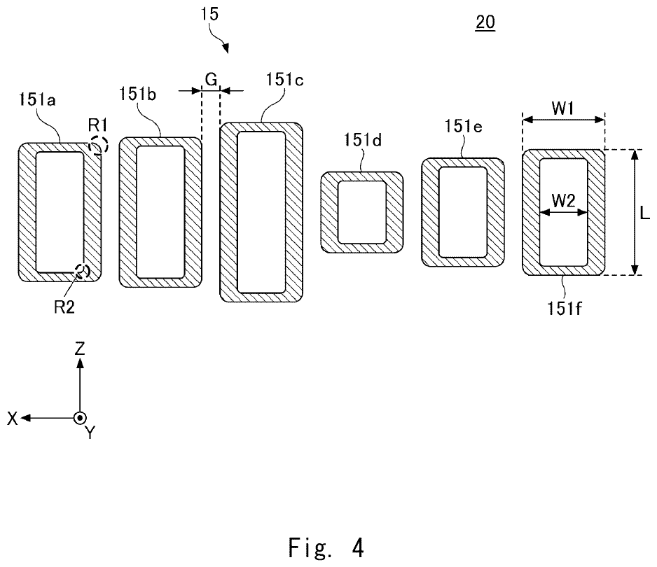

The conductive pattern 15 includes a periodic array of a plurality of hollow patterns 151. A specific shape of each of the hollow patterns 151 will be described later with reference to FIG. 4. The hollow pattern is formed of a good conductor such as Ag, Cu, Ni, or Al as an example, and has a thickness of 0.01 mm or larger and 0.05 mm or smaller as an example. When it has a thickness of less than 0.01 mm, the surface resistivity increases, and hence it becomes difficult to maintain a high reflection efficiency. When it has a thickness of 0.05 mm or larger, it becomes difficult to maintain the flatness of the reflection surface. The surface of the conductive pattern 15 may be protected by a transparent film having a dielectric constant and a dielectric loss tangent equal to those of the dielectric layer 11.

As an example, the hollow pattern 151 is bonded to the dielectric layer 11 by an adhesive layer 13. As an example, the adhesive layer 13 is not applied to the entire surface of the dielectric layer 11, and an amount of the adhesive layer 13 required to stably support the hollow pattern 151 is used instead. This configuration aims to minimize the influence of the adhesive layer 13 on the dielectric constant of the dielectric layer 11. The area occupied by the adhesive layer 13 does not need to be exactly the same as the area occupied by the conductive pattern 15, and a slight deviation may be allowed as long as the hollow pattern 151 can be stably bonded to the dielectric layer 11. For example, if the area occupancy rate of the conductive pattern 15 to the dielectric layer 11 is 10.0% or higher and 45.0% or lower, the area occupancy rate of the adhesive layer 13 to the dielectric layer 11 is 9.0% or higher and 50.0% or lower.

If the area occupancy rate of the conductive pattern 15 is less than 10.0%, it becomes difficult to achieve desired reflection characteristics and reflection efficiency. If the area occupancy rate of the conductive pattern 15 exceeds 45.0%, it becomes difficult to maintain the transparency of the reflection panel 10. However, for applications that do not require the transparency, the area occupancy rate of the conductive pattern 15 may be increased to 45.0% or higher to give a high priority to the reflection efficiency.

The adhesive layer 13 is a material by which the conductive pattern 15 can be bonded to the dielectric layer 11, and a thermoplastic resin such as a vinyl acetate resin, an acrylic resin, a cellulose resin, or a silicone resin may be used for the adhesive layer 13. The thickness of the adhesive layer 13 is a thickness that enables the conductive pattern 15 to be stably bonded to the dielectric layer 11, and is, for example, 0.002 mm or larger and 0.050 mm or smaller. In order to secure the adhesive strength, the thickness thereof is preferably 0.010 mm or larger and 0.050 mm or smaller.

The dielectric layer 11 is an insulating polymer film made of polycarbonate, cycloolefin polymer (COP), polyethylene terephthalate (PET), a fluorine resin, or the like, and has a thickness of about 0.3 mm to 1.0 mm. The dielectric layer 11 may be any material having a relative dielectric constant and a dielectric loss tangent suitable for achieving a target reflection characteristic.

The ground layer 12 may be formed of a material the same as or different from the conductive pattern 15. The ground layer 12 forms a predetermined parasitic capacitance between it and the conductive pattern 15. The amount of phase delay is determined by the parasitic capacitance formed between the conductive pattern 15 and the ground layer 12.

Note that, as an example, the reflection panel 10 may be sandwiched between two dielectric substrates. The above dielectric substrate may be transparent to electromagnetic waves in bands from the gigahertz band to the terahertz band, specifically, electromagnetic waves of 1 MHz or higher and 3 THz or lower, for example, electromagnetic waves of 1 MHz or higher and 300 GHz or lower. The dielectric substrate is preferably formed of a material excellent in impact resistance, durability, and transparency as the outermost layer of the reflection panel 10. Polycarbonate, an acrylic resin, PET, or the like may be used for the dielectric substrate. The thickness of one dielectric substrate may be selected from the range of, for example, from 1.0 mm to 10.0 mm as appropriate in accordance with a place where it is installed. The thicknesses of the two dielectric substrates may be the same as or different from each other.

### Configuration Example of the Hollow Pattern

FIG. 4 is a diagram showing an example of a configuration of a unit cell 20 of the conductive pattern 15 composed of the hollow patterns 151. FIG. 4 shows, as an example, a configuration of the reflection panel 10 of the electromagnetic-wave reflecting apparatus 60 disposed on the −Y direction side of the road 32 or the production line 35 when viewed from the +Y direction side.

In the example shown in FIG. 4, the unit cell 20 includes six hollow patterns 151a, 151b, 151c, 151d, 151e, and 151f. The direction of a width W1 and the direction of a length L of each of the hollow patterns 151a to 151f correspond to the width (X) direction and the height (Z) direction of the reflection panel 10 shown in FIG. 2A, respectively. Although the hollow patterns 151a to 151f have the same width W1 as each other and the lengths L different from each other, the central axes of their lengths are aligned (the Y coordinate positions of the central axes are the same). The pitches or intervals G between them in the X direction are the same. The phase of reflection is controlled by the shapes and the sizes of the hollow patterns 151a to 151f, and a reflection beam is formed in a desired direction by superimposing reflected waves. In this example, the unit cell 20 is designed so as to reflect a beam of a reflected wave of an electromagnetic wave incident normally (an incident angle of 0°) in a direction of 50° from the normal.

The hollow patterns 151a, 151b, 151c, 151d, 151e, and 151f (hereinafter may collectively be referred to as “hollow patterns 151”) are hollow with a width W2. The hollow pattern has a rectangular ring shape in an XZ plane view. Note that ½ of the difference between the width W1 of the outer periphery of each of the hollow patterns 151 and the width W2 of the inner periphery of the same is the width of the line segment of the hollow pattern 151 in the vertical direction. Similarly, the thickness of the line segment of the hollow pattern 151 in the horizontal direction is determined in accordance with the area of the hollow. Both vertically and horizontally polarized waves can be reflected by the line segments of the hollow pattern 151 in the vertical and the horizontal directions.

Each corner part of the hollow pattern 151 on the outer edge thereof may be a right angle without curvature or may be curved with a radius of curvature R1. In the case of a right angle, the radius of curvature R1=0.0 mm. Each corner part of the inner periphery of the hollow pattern 151 is curved with a radius of curvature R2. The radius of curvature R1 is equal to or smaller than the radius of curvature R2. By rounding each of the corner parts of the hollow pattern 151, in particular, each of the corner parts thereof on the inner edge side, with a predetermined radius of curvature, the concentration of current is prevented and the reflection efficiency is maintained. Specifically, by rounding each of the corner parts of the hollow pattern 151 on the inner edge side with the radius of curvature R2 of 1/10 or larger and ½ or smaller of the width W1, the hollow pattern 151 can respond to both vertically and horizontally polarized waves while reducing the concentration of current.

The conductive pattern 15 is a periodic pattern in which the unit cells 20 are repeatedly disposed in the X and the Z directions. By providing a reflection surface formed by the conductive pattern 15 in at least a part of the reflection panel 10, both incident horizontally and vertically polarized electromagnetic waves can be reflected in a controlled direction.

### Results of Experiments

In an indoor facility having a length of 100.0 m, a width of 50.0 m, and a ceiling height of 10.0 m, an experiment was conducted in a space in which a production line for assembling parts of vehicles was disposed at the center thereof, and a plurality of structures such as metal racks, autonomous mobile robots such as AGVs, and robot arms are present near the production line. In this indoor facility, when the electromagnetic-wave reflecting apparatus 60 and the leaky coaxial cable 80 were not disposed, blind zones were present at the back sides of the structures. In the following description, the width of the electromagnetic-wave reflecting apparatus 60 is defined as the width in the X direction in FIG. 2B, and the height of the electromagnetic-wave reflecting apparatus 60 is defined as the height in the Z direction.

### Example 1

Example 1 is Implementation Example 1 (i.e., Example 1 according to the present disclosure). A base station including an antenna having a maximum output of 20 dBm and a half power beam width of 15° in the vertical direction and 30° in the horizontal direction was disposed at a position of 7.5 m in the X direction from the end of the electromagnetic-wave reflecting apparatus 60 to which the base station was connected in the X direction and at a height of 5.0 m, and radio waves in a frequency band of 28.2 GHz were transmitted and received.

On respective sides of the production line in the width direction, 30 of the electromagnetic-wave reflecting apparatuses 60 each having a width of 1.0 m×a height of 2.0 m were provided, and they were connected to each other along the production line, whereby electromagnetic-wave reflecting fences 100A of 30.0 m were provided. The electromagnetic wave reflection fences 100A on the respective sides of the production line were disposed parallel to the production line, and the interval therebetween was set to 10.0 m.

The leaky coaxial cable 80 was provided on the reflection surface of the electromagnetic-wave reflecting apparatus 60 of the electromagnetic-wave reflecting fence 100A, and connected to an antenna terminal of the base station. The direction of each of the slots 83A of the leaky coaxial cable 80 was set so that a radio wave emitted from the slot 83A propagates toward the production line and the plurality of structures such as metal racks, autonomous mobile robots such as AGVs, and robot arms. Before and after the installation of the electromagnetic-wave reflecting apparatus 60 and the leaky coaxial cable 80, the radio wave intensity in the blind zone has been changed from −110.0 dBm to −85.0 dBm, and an improvement of +25.0 dB has been confirmed. Further, before and after the installation of the electromagnetic-wave reflecting apparatus 60 and the leaky coaxial cable 80, the radio wave intensity on the outside of the electromagnetic-wave reflecting apparatus 60 (on the back side thereof when viewed from the production line) remained unchanged at −125.0 dBm.

As described above, in Example 1, it has been confirmed that, by installing the electromagnetic-wave reflecting apparatus 60 and the leaky coaxial cable 80, the blind zones in the production line are reduced and that the leakage of radio waves to the outside of the area where the electromagnetic-wave reflecting apparatus 60 and the leaky coaxial cable 80 are provided can be reduced.

### Example 2

Example 2 is Implementation Example 2. A base station including an antenna having a maximum output of 20 dBm and a half power beam width of 15° in the vertical direction and 30° in the horizontal direction was disposed at a position of 5.0 m in the X direction from the end of the electromagnetic-wave reflecting apparatus 60 to which the base station was connected in the X direction and at a height of 10.0 m, and radio waves in a frequency band of 28.2 GHz were transmitted and received.

On respective sides of the production line in the width direction, 30 of the electromagnetic-wave reflecting apparatuses 60 each having a width of 1.0 m×a height of 2.0 m were provided, and they were connected to each other along the production line, whereby electromagnetic-wave reflecting fences 100A of 30.0 m were provided. The electromagnetic wave reflection fences 100A on the respective sides of the production line were disposed parallel to the production line, and the interval therebetween was set to 10.0 m.

The leaky coaxial cable 80 was suspended from the ceiling, installed at a position 30 cm above the upper end of the electromagnetic-wave reflecting apparatus 60 of the electromagnetic-wave reflecting fence 100A, and connected to an antenna terminal of the base station. The direction of each of the slots 83A of the leaky coaxial cable 80 was set so that a radio wave emitted from the slot 83A propagates toward the production line and the plurality of structures such as metal racks, autonomous mobile robots such as AGVs, and robot arms. Before and after the installation of the electromagnetic-wave reflecting apparatus 60 and the leaky coaxial cable 80, the radio wave intensity in the blind zone has been changed from −110.0 dBm to −92.0 dBm, and an improvement of +18.0 dB has been confirmed.

Further, before and after the installation of the electromagnetic-wave reflecting apparatus 60 and the leaky coaxial cable 80, the radio wave intensity on the outside of the electromagnetic-wave reflecting apparatus 60 (on the back side thereof when viewed from the production line) remained unchanged at −125.0 dBm.

As described above, in Example 2, it has been confirmed that, by installing the electromagnetic-wave reflecting apparatus 60 and the leaky coaxial cable 80, the blind zones in the production line are reduced and that the leakage of radio waves to the outside of the area where the electromagnetic-wave reflecting apparatus 60 and the leaky coaxial cable 80 are provided can be reduced. It has been found that, since the degree of improvement in the radio wave intensity was smaller than that in Example 1, the effect of improving the radio wave intensity is greater when the leaky coaxial cable 80 is disposed on the reflection surface of the electromagnetic-wave reflecting apparatus 60.

### Example 3

Example 3 is Implementation Example 3. A base station including an antenna having a maximum output of 20 dBm and a half power beam width of 15° in the vertical direction and 30° in the horizontal direction was disposed at a position of 10.0 m in the X direction from the end of the electromagnetic-wave reflecting apparatus 60 to which the base station was connected in the X direction and at a height of 10.0 m, and radio waves in a frequency band of 28.2 GHz were transmitted and received.

On respective sides of the production line in the width direction, 30 of the electromagnetic-wave reflecting apparatuses 60 each having a width of 1.0 m×a height of 2.0 m were provided, and they were connected to each other along the production line, whereby electromagnetic-wave reflecting fences 100A of 30.0 m were provided. The electromagnetic wave reflection fences 100A on the respective sides of the production line were disposed parallel to the production line, and the interval therebetween was set to 20.0 m.

The leaky coaxial cable 80 was suspended from the ceiling, installed at a position 50 cm above the upper end of the electromagnetic-wave reflecting apparatus 60 of the electromagnetic-wave reflecting fence 100A, and connected to an antenna terminal of the base station. The direction of each of the slots 83A of the leaky coaxial cable 80 was set so that a radio wave emitted from the slot 83A propagates toward the production line and the plurality of structures such as metal racks, autonomous mobile robots such as AGVs, and robot arms. Before and after the installation of the electromagnetic-wave reflecting apparatus 60 and the leaky coaxial cable 80, the radio wave intensity in the blind zone has been changed from −110.0 dBm to −100.0 dBm, and an improvement of +10.0 dB has been confirmed. Further, before and after the installation of the electromagnetic-wave reflecting apparatus 60 and the leaky coaxial cable 80, the radio wave intensity on the outside of the electromagnetic-wave reflecting apparatus 60 (on the back side thereof when viewed from the production line) remained unchanged at −125.0 dBm.

As described above, in Example 3, it has been confirmed that, by installing the electromagnetic-wave reflecting apparatus 60 and the leaky coaxial cable 80, the blind zones in the production line are reduced and that the leakage of radio waves to the outside of the area where the electromagnetic-wave reflecting apparatus 60 and the leaky coaxial cable 80 are provided can be reduced. It has been found that, since the degree of improvement in the radio wave intensity was smaller than that in Example 1, the effect of improving the radio wave intensity is greater when the leaky coaxial cable 80 is disposed on the reflection surface of the electromagnetic-wave reflecting apparatus 60. Further, since the height of the leaky coaxial cable 80 was set higher than that in Example 2, the effect of reducing the blind zones was small.

### Example 4

Example 4 is Comparative Example 1. In Example 4, an experiment, in which the leaky coaxial cable 80 was not provided and only the electromagnetic-wave reflecting apparatus 60 was instead provided, was conducted. The experimental condition of Example 4 is the one obtained by omitting the leaky coaxial cable 80 from that of Example 2.

A base station including an antenna having a maximum output of 20 dBm and a half power beam width of 15° in the vertical direction and 30° in the horizontal direction was disposed at a position of 5.0 m in the X direction from the end of the electromagnetic-wave reflecting apparatus 60 to which the base station was connected in the X direction and at a height of 10.0 m, and radio waves in a frequency band of 28.2 GHz were transmitted and received.

On respective sides of the production line in the width direction, 30 of the electromagnetic-wave reflecting apparatuses 60 each having a width of 1.0 m×a height of 2.0 m were provided, and they were connected to each other along the production line, whereby electromagnetic-wave reflecting fences 100A of 30.0 m were provided. The electromagnetic wave reflection fences 100A on the respective sides of the production line were disposed parallel to the production line, and the interval therebetween was set to 10.0 m.

It has been confirmed that, when a radio wave was emitted from the antenna of the base station, the radio wave intensity in the blind zone has been changed from −110.0 dBm to −108.0 dBm, and the improvement in the radio wave intensity was only +2.0 dB. Further, the radio wave intensity on the outside of the electromagnetic-wave reflecting apparatus 60 (on the back side thereof when viewed from the production line) remained unchanged at −85.0 dBm.

### Example 5

Example 5 is Comparative Example 2. In Example 5, an experiment, in which the electromagnetic-wave reflecting apparatus 60 was not provided and only the leaky coaxial cable 80 was instead provided, was conducted. The experimental condition of Example 5 is the one obtained by omitting the electromagnetic-wave reflecting apparatus 60 from that of Example 2.

A base station including an antenna having a maximum output of 20 dBm and a half power beam width of 15° in the vertical direction and 30° in the horizontal direction was disposed at a position of 25.0 m in the X direction from the end of the electromagnetic-wave reflecting apparatus 60 to which the base station was connected in the X direction and at a height of 10.0 m, and radio waves in a frequency band of 28.2 GHz were transmitted and received.

The leaky coaxial cable 80 was disposed at the same position as the leaky coaxial cable 80 in Example 2 on each of the respective sides of the production line in the width direction, and connected to an antenna terminal of the base station, and the direction of each of the slots 83A of the leaky coaxial cable 80 was set so that a radio wave emitted from the slot 83A propagates toward the production line and the plurality of structures such as metal racks, autonomous mobile robots such as AGVs, and robot arms.

It has been confirmed that, when a radio wave was emitted from the slot 83A of the leaky coaxial cable 80, the radio wave intensity in the blind zone has been changed from −110.0 dBm to −108.0 dBm, and the improvement in the radio wave intensity was only +2.0 dB. Further, the radio wave intensity on the outside of the production line remained unchanged at −115.0 Bm. The position on the outside of the production line was the same as the position on the back side of the electromagnetic-wave reflecting apparatus 60 in each of Examples 1 to 4.

From the results of the experiments of Examples 1 to 5, it has been confirmed that, by installing both the electromagnetic-wave reflecting apparatus 60 and the leaky coaxial cable 80, the blind zones in the production line are reduced and that the leakage of radio waves to the outside of the area where the electromagnetic-wave reflecting apparatus 60 and the leaky coaxial cable 80 are provided can be reduced. Further, it has been confirmed that the effect of improving the radio wave intensity in the blind zone is greater when the leaky coaxial cable 80 is disposed on the reflection surface of the electromagnetic-wave reflecting apparatus 60 than when it is disposed above the upper end of the electromagnetic-wave reflecting apparatus 60.

### Effect

The radio transmission system 1 includes: a plurality of the electromagnetic-wave reflecting apparatuses 60 provided on respective sides of a passage along a traveling direction of the passage, each of the electromagnetic-wave reflecting apparatuses 60 being configured to reflect a radio wave in a predetermined band selected from 1 MHz or higher and 300 GHz or lower; and the leaky coaxial cable 80 disposed in an area surrounded by the plurality of the electromagnetic-wave reflecting apparatuses 60 provided on the respective sides of the passage and a floor surface of the passage, the leaky coaxial cable 80 being connected to the base station 33. Therefore, the leaky coaxial cable 80 can emit a radio wave along the passage. Further, the plurality of the electromagnetic-wave reflecting apparatuses 60 can reflect a radio wave in an area surrounded by the electromagnetic-wave reflecting apparatuses 60 which are provided on the respective sides of the passage and the floor surface of the passage, and the occurrence of leakage of radio waves to the outside of the area can be reduced.

Therefore, it is possible to provide the radio transmission system 1 which achieves both the improvement of a radio-wave propagation environment and the reduction of the occurrence of leakage of radio waves to the outside of a required space.

Further, the leaky coaxial cable 80 may be fixed to the plurality of the electromagnetic-wave reflecting apparatuses 60. By using the plurality of the electromagnetic-wave reflecting apparatuses 60, the leaky coaxial cable 80 can be easily disposed along the passage. Further, since a radio wave can be reliably emitted from the leaky coaxial cable 80 to the passage, the blind zones can be effectively reduced.

Further, the area may have a ceiling, and the leaky coaxial cable 80 may be suspended from the ceiling. By using the ceiling, the leaky coaxial cable 80 can be easily disposed along the passage. Further, since a radio wave can be reliably emitted from the leaky coaxial cable 80 to the passage, the blind zones can be effectively reduced.

Further, a height wise position of the leaky coaxial cable 80 may be equal to or lower than a height wise position of an upper end of each of the plurality of the electromagnetic-wave reflecting apparatuses 60. Since a larger amount of radio waves emitted from the leaky coaxial cable 80 is reflected in an area surrounded by the electromagnetic-wave reflecting apparatuses 60 which are provided on the respective sides of the passage and the floor surface of the passage, the blind zones can be reduced more effectively and the occurrence of leakage of radio waves to the outside of the area can be reduced.

Further, the leaky coaxial cable 80 includes a plurality of the slots 83A which emit radio waves, and the plurality of the slots 83A may be directed to a center side of the passage in a width direction. By making radio waves emitted from the slots 83A propagate to the area surrounded by the electromagnetic-wave reflecting apparatuses 60 which are provided on the respective sides of the passage and the floor surface of the passage, the blind zones can be effectively reduced.

Further, the distance D between each of the plurality of the electromagnetic-wave reflecting apparatuses 60 and the leaky coaxial cable 80 may be a distance that satisfies D≠(¼+N)×λ, where λ is a wavelength of the radio wave in a free space and N is any natural number. It is possible to prevent a radio wave emitted from the slot 83A of the leaky coaxial cable 80 to the center side of the road 32 in the width direction and a radio wave reflected by the electromagnetic-wave reflecting apparatus 60 to the center side of the road 32 in the width direction from being in opposite phase, and hence prevent the radio waves from canceling each other out.

Further, the distance D between each of the plurality of the electromagnetic-wave reflecting apparatuses 60 and the leaky coaxial cable 80 may be 0.3 m or shorter. When the distance D is long, the intensity of the reflected wave that is reflected from the leaky coaxial cable 80 by the electromagnetic-wave reflecting apparatus 60 and propagated to the center side of the road 32 in the width direction decreases. Therefore, if the leaky coaxial cable 80 is moderately close to the electromagnetic-wave reflecting apparatus 60, the intensity of the reflected wave is increased, and hence the blind zones can be reduced.

Further, a width of the passage may be 5 m to 20 m. In the above realistic width of the passage, it is possible to achieve both the improvement of a radio-wave propagation environment and the reduction of the occurrence of leakage of radio waves to the outside of a required space.

Although an illustrative radio transmission system according to the present disclosure has been described above, the present disclosure is not limited to the embodiments specifically disclosed, and various modifications and changes can be made without departing from the scope of the claims.

The following supplementary notes are further disclosed regarding the above-described embodiments.

### (Supplementary Note 1)

A radio transmission system comprising:
a plurality of electromagnetic-wave reflecting apparatuses provided on respective sides of a passage along a traveling direction of the passage, each of the electromagnetic-wave reflecting apparatuses being configured to reflect a radio wave in a predetermined band selected from 1 MHz or higher and 300 GHz or lower; and
a leaky coaxial cable disposed in an area surrounded by the plurality of the electromagnetic-wave reflecting apparatuses provided on the respective sides of the passage and a floor surface of the passage, the leaky coaxial cable being connected to a base station.

### (Supplementary Note 2)

The radio transmission system according to supplementary note 1, wherein the leaky coaxial cable is fixed to the plurality of the electromagnetic-wave reflecting apparatuses.

### (Supplementary Note 3)

The radio transmission system according to supplementary note 1, wherein
the area has a ceiling, and
the leaky coaxial cable is suspended from the ceiling.

### (Supplementary Note 4)

The radio transmission system according to any one of supplementary notes 1 to 3, wherein a height wise position of the leaky coaxial cable is equal to or lower than a height wise position of an upper end of each of the plurality of the electromagnetic-wave reflecting apparatuses.

### (Supplementary Note 5)

The radio transmission system according to any one of supplementary notes 1 to 4, wherein
the leaky coaxial cable includes a plurality of slots configured to emit radio waves, and
the plurality of slots are directed to a center side of the passage in a width direction.

### (Supplementary Note 6)

The radio transmission system according to any one of supplementary notes 1 to 5, wherein a distance D between each of the plurality of the electromagnetic-wave reflecting apparatuses and the leaky coaxial cable is a distance that satisfies D≠(¼+N)×λ, where λ is a wavelength of the radio wave in a free space and N is any natural number.

### (Supplementary Note 7)

The radio transmission system according to any one of supplementary notes 1 to 6, wherein the distance D between each of the plurality of the electromagnetic-wave reflecting apparatuses and the leaky coaxial cable is 0.3 m or shorter.

### (Supplementary Note 8)

The radio transmission system according to any one of supplementary notes 1 to 7, wherein a width of the passage is 5 m to 20 m.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A radio transmission system comprising:
a plurality of electromagnetic-wave reflecting apparatuses provided on respective sides of a passage along a traveling direction of the passage, each of the electromagnetic-wave reflecting apparatuses being configured to reflect a radio wave in a predetermined band selected from 1 MHz or higher and 300 GHz or lower; and
a leaky coaxial cable disposed in an area surrounded by the plurality of the electromagnetic-wave reflecting apparatuses provided on the respective sides of the passage and a floor surface of the passage, the leaky coaxial cable being connected to a base station.

2. The radio transmission system according to claim 1, wherein the leaky coaxial cable is fixed to the plurality of the electromagnetic-wave reflecting apparatuses.

3. The radio transmission system according to claim 1, wherein
the area has a ceiling, and
the leaky coaxial cable is suspended from the ceiling.

4. The radio transmission system according to claim 1, wherein a height wise position of the leaky coaxial cable is equal to or lower than a height wise position of an upper end of each of the plurality of the electromagnetic-wave reflecting apparatuses.

5. The radio transmission system according to claim 1, wherein
the leaky coaxial cable includes a plurality of slots configured to emit radio waves, and
the plurality of slots are directed to a center side of the passage in a width direction.

6. The radio transmission system according to claim 1, wherein a distance D between each of the plurality of the electromagnetic-wave reflecting apparatuses and the leaky coaxial cable is a distance that satisfies D≠(¼+N)×λ, where λ is a wavelength of the radio wave in a free space and N is any natural number.

7. The radio transmission system according to claim 1, wherein the distance D between each of the plurality of the electromagnetic-wave reflecting apparatuses and the leaky coaxial cable is 0.3 m or shorter.

8. The radio transmission system according to claim 1, wherein a width of the passage is 5 m to 20 m.
